(19) United States
(12) Patent Application Publication
(10) Pub. No.: US 2021/0224397 A1
(43) Pub. Date: Jul. 22, 2021

(54) INFORMATION PROCESSING DEVICE, INFORMATION PROCESSING METHOD, AND COMPUTER READABLE MEDIUM

(71) Applicant: MITSUBISHI ELECTRIC CORPORATION, Tokyo (JP)

(72) Inventors: Takumi YAMAMOTO, Tokyo (JP); Ryosuke SHIMABE, Tokyo (JP); Takeshi ASAI, Tokyo (JP); Kiyoto KAWAUCHI, Tokyo (JP)

(73) Assignee: MITSUBISHI ELECTRIC CORPORATION, Tokyo (JP)

(21) Appl. No.: 17/199,894

(22) Filed: Mar. 12, 2021

Related U.S. Application Data
(63) Continuation of application No. PCT/JP2018/040641, filed on Nov. 1, 2018.

(51) Int. Cl. G06F 21/57

(52) U.S. Cl. CPC G06F 21/577; G06F 2221/034

(57) ABSTRACT

An evaluation tree generation unit (101) generates as an evaluation tree, an attack tree about an information system, which is based on inference using predicate logic. A gold tree generation unit (102) generates a gold tree which covers an intrusion route to the information system and reflects an intrusion procedure for the information system, by using network configuration information indicating a network configuration of the information system and intrusion procedure information indicating an intrusion procedure assumed in intrusion into the information system. A tree comparison unit (103) compares the evaluation tree with the gold tree.

### CROSS REFERENCE TO RELATED APPLICATIONS

This application is a Continuation of PCT International Application No. PCT/JP2018/040641 filed on Nov. 1, 2018, which is hereby expressly incorporated by reference into the present application.

### TECHNICAL FIELD

The present invention relates to an evaluation of an attack tree.

### BACKGROUND ART

In recent years, importance of security in enterprises which handle information assets has increased due to leakage incidents of confidential information or personal information, damage caused by ransomware, and the like. In addition, with networking of control systems, a cyberattack on an important infrastructure such as a power plant and a gas plant has gradually become a threat. These cyberattacks have become a serious concern matter that undermines national security. A typical example of an attack on an important infrastructure is Stuxnet that has occurred at a nuclear power plant in Iran. In this example, it is said that a machine on an internal network that manipulates a control system was infected with malware via a USB memory and further a program that controls a centrifuge was tampered with and unauthorized operation of the centrifuge affected production of enriched uranium. The centrifuge and the like were not connected to the Internet (air-gapped). However, a USB memory utilized by in-house staff is reported as one of attack routes. From this, it is understood that it is necessary to anticipate various threats in advance to improve security.

In order to improve the security, first of all, security analysis to clarify threats to an attack goal and its risk is important. In the security analysis, the threats to the attack goal are listed. Next, high risk values are assigned to threats that occur frequently and have a significant impact. Then, appropriate measures are implemented to threats to which high-risk values are assigned.

When listing the threats, it is meaningless if a threat is left out from the list. Therefore, a tool such as an attack tree is used to systematically extract an intrusion procedure for the attack goal.

Conventionally, the attack tree has been created by a person. Therefore, quality of the created attack tree has depended on creator's creativity, experience, and skill. Coverage of the created attack tree has always been questioned since mistakes can sneak in at a time of creation.

Therefore, a technique has been considered in which the intrusion procedure for the attack goal is inferred based on given prerequisite knowledge by utilizing an inference engine of predicate logic such as Prolog, and the attack tree is automatically generated from inference process (For example, Non-Patent Literature 1 and Non-Patent Literature 2). Hereinafter, a technique for automatically generating such an attack tree will be referred to as an attack tree automatic generation technique. According to the attack tree automatic generation technique, coverage of the attack tree does not depend on creativity and experience of a person, because there is no human involvement during attack tree generation process. In this technique, it is inferred as to whether or not a given attack goal succeeds, based on prerequisite knowledge and an inference rule prepared in advance. All combinations are attempted and the attack tree is generated based only on successful inference process. Since creation of the attack tree does not include human involvement, the attack tree is less likely to be affected by the creator's abilities and mistakes.

However, even in the attack tree automatic generation technique, it is necessary to prepare, by a person, the knowledge and the inference rule to be given to the inference engine. For this reason, a basis for the coverage of the attack tree which is generated using the attack tree automatic generation technique, cannot be strongly alleged.

Further, in a technique of Non-Patent Literature 3, the attack tree is evaluated by utilizing a type certificate. The attack tree is generated in a certain model (Transition system model). The coverage and soundness of the attack tree is guaranteed in the model. However, since the model is created by a person, the model may vary due to differences in experience and knowledge. In addition, it is likely that a mistake by a person snakes in the creation of the model. Therefore, the coverage and soundness guaranteed in the model remains questionable.

### CITATION LIST

### Patent Literature

Non Patent Literature 1: Xinming Ou, Sudhakar Govindavajhala, Andrew W. Appel, MulVAL: A Logic-based Network Security Analyzer, Proceeding SSYM '05 Proceedings of the 14th conference on USENIX Security Symposium-Volume 14

Non Patent Literature 2: Takeshi Asai, Ryosuke Shimabe, Kiyoto Kawauchi, Automatic generation of attack tree for selecting cybersecurity measures, SCIS2018 Cryptography and Information Security Symposium, 1C1-1

Non Patent Literature 3: Maxime Audinot, Sophie Pinchinat, Barbara Kordy, Is my attack tree correct? Extended version, CoRR abs/1706.08507 (2017)

### SUMMARY OF INVENTION

### Technical Problem

As described above, conventional techniques have a problem that the coverage of the generated attack tree remains questionable.

The present invention aims to solve such a problem. Specifically, the present invention mainly aims to improve the coverage of the attack tree.

### Solution to Problem

An information processing device according to the present invention includes:

a first attack tree acquisition unit to acquire as a first attack tree, an attack tree about an information system, which is based on inference using predicate logic;

a second attack tree generation unit to generate as a second attack tree, an attack tree which covers an intrusion route to the information system and reflects an intrusion procedure for the information system, by using network configuration information indicating a network configuration of the information system and intrusion procedure information indicating an intrusion procedure assumed in intrusion into the information system; and

a tree comparison unit to compare the first attack tree with the second attack tree.

### Advantageous Effects of Invention

In the present invention, since a first attack tree is compared with a second attack tree that covers an intrusion route to an information system and reflects an intrusion procedure for the information system, it is possible to evaluate coverage of the first attack tree. For this reason, it is possible to give a feedback of an evaluation result to a generation procedure of the first attack tree and increase the coverage of the first attack tree.

### BRIEF DESCRIPTION OF DRAWINGS

FIG. 1 is a diagram illustrating a hardware configuration example of a coverage evaluation device according to a first embodiment;

FIG. 2 is a diagram illustrating a functional configuration example of the coverage evaluation device according to the first embodiment;

FIG. 3 is a flowchart illustrating an operation example of the coverage evaluation device according to the first embodiment;

FIG. 4 is a diagram illustrating an example of attack knowledge according to the first embodiment;

FIG. 5 is a diagram illustrating an example of system knowledge according to the first embodiment;

FIG. 6 is a diagram illustrating an example of a tree representing inference process according to the first embodiment;

FIG. 7 is a diagram illustrating an example of an attack tree according to the first embodiment;

FIG. 8 is a diagram illustrating an internal configuration example of a gold tree generation unit according to the first embodiment;

FIG. 9 is a flowchart illustrating an operation example of the gold tree generation unit according to the first embodiment;

FIG. 10 is a diagram illustrating a network configuration example of a control system according to the first embodiment;

FIG. 11 is a diagram illustrating an example of a tree covering intrusion routes according to the first embodiment;

FIG. 12 is a diagram illustrating an example of an initial-stage intrusion template according to the first embodiment;

FIG. 13 is a diagram illustrating an example of the initial-stage intrusion template according to the first embodiment;

FIG. 14 is a diagram illustrating an example of an intrusion procedure template according to the first embodiment;

FIG. 15 is a diagram illustrating an example of the intrusion procedure template according to the first embodiment;

FIG. 16 is a diagram illustrating an example of a tree after the initial-stage intrusion template and the intrusion procedure template are applied, according to the first embodiment;

FIG. 17 is a diagram illustrating an example of a tree after the initial-stage intrusion template and the intrusion procedure template are applied, according to the first embodiment;

FIG. 18 is a diagram illustrating an example of a tree after the initial-stage intrusion template and the intrusion procedure template are applied, according to the first embodiment;

FIG. 19 is a diagram illustrating an internal configuration example of a tree comparison unit according to the first embodiment;

FIG. 20 is a flowchart illustrating an operation example of the tree comparison unit according to the first embodiment;

FIG. 21 is a diagram illustrating an example of an evaluation tree according to the first embodiment;

FIG. 22 is a diagram illustrating an example of an evaluation tree according to the first embodiment;

FIG. 23 is a diagram illustrating a pseudo code that realizes comparison operation according to the first embodiment;

FIG. 24 is a diagram illustrating an internal configuration example of a tree comparison unit according to a second embodiment;

FIG. 25 is a flowchart illustrating an operation example of the tree comparison unit according to the second embodiment;

FIG. 26 is a diagram illustrating an example of a failure tree according to the second embodiment;

FIG. 27 is a diagram illustrating a pseudo code that realizes comparison operation according to the second embodiment; and

FIG. 28 is a diagram illustrating an example of an evaluation tree including an AND node and an OR node according to the first embodiment.

### DESCRIPTION OF EMBODIMENTS

Hereinafter, embodiments of the present invention will be described with reference to the drawings. In the following description of the embodiments and the drawings, the same reference numerals indicate the same or corresponding parts.

### First Embodiment

### Description of Configuration

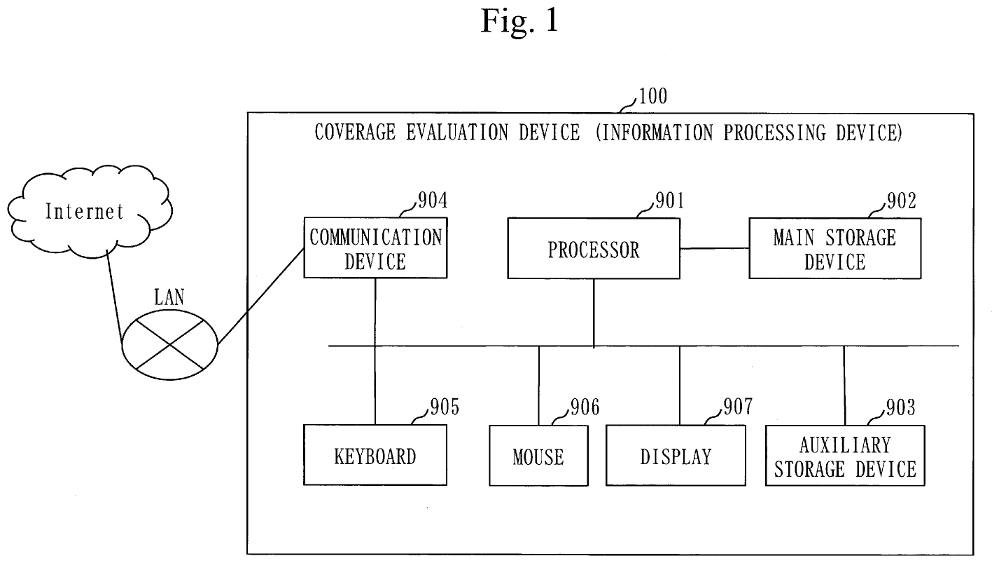

FIG. 1 illustrates a hardware configuration example of a coverage evaluation device 100 according to the present embodiment.

The coverage evaluation device 100 corresponds to an information processing device. Further, operation performed by the coverage evaluation device 100 corresponds to an information processing method and an information processing program.

The coverage evaluation device 100 according to the present embodiment is a computer.

The coverage evaluation device 100 includes a processor 901, a main storage device 902, an auxiliary storage device 903, a communication device 904, a keyboard 905, a mouse 906, and a display 907 as hardware.

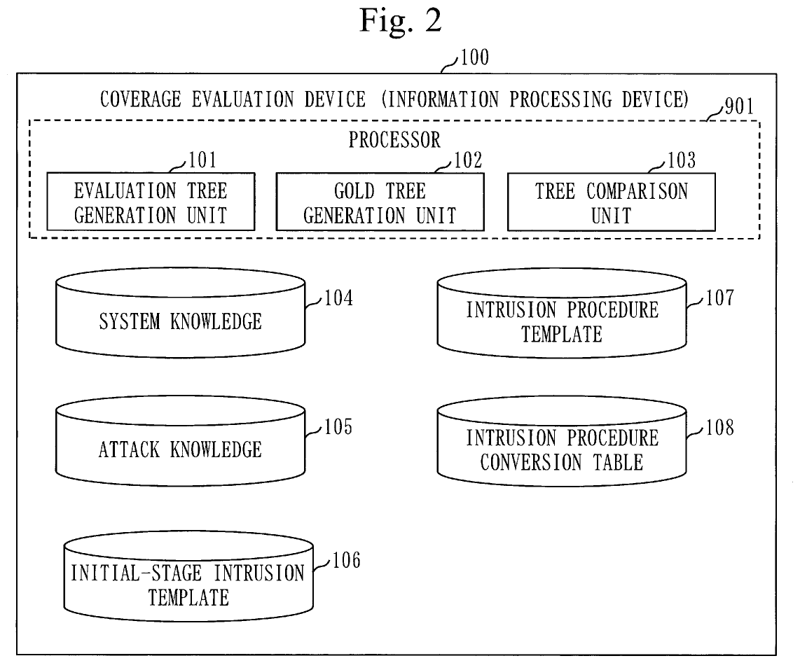

The auxiliary storage device 903 stores a program that realizes functions of an evaluation tree generation unit 101, a gold tree generation unit 102, and a tree comparison unit 103, which are described later with reference to FIG. 2. The program is loaded from the auxiliary storage device 903 into the main storage device 902. Then, the processor 901 executes the program to perform operations of the evaluation tree generation unit 101, the gold tree generation unit 102, and the tree comparison unit 103, which are described later.

The main storage device 902 or the auxiliary storage device 903 stores data to be used by the evaluation tree generation unit 101, the gold tree generation unit 102, and the tree comparison unit 103. Further, the main storage device 902 or the auxiliary storage device 903 stores data indicating processing results of the evaluation tree generation unit 101, the gold tree generation unit 102, and the tree comparison unit 103.

The communication device 904 is connected to the Internet via, for example, a LAN (Local Area Network).

The keyboard 905 and the mouse 906 are used by a user of the coverage evaluation device 100 to input various types of instructions into the coverage evaluation device 100.

The display 907 is used to display various types of information to the user of the coverage evaluation device 100.

FIG. 2 illustrates a functional configuration example of the coverage evaluation device 100 according to the present embodiment.

The coverage evaluation device 100 includes the evaluation tree generation unit 101, the gold tree generation unit 102, and the tree comparison unit 103.

As described above, the evaluation tree generation unit 101, the gold tree generation unit 102, and the tree comparison unit 103 are realized by, for example, a program. Then, the program is executed by the processor 901.

FIG. 2 schematically indicates a state in which the processor 901 executes the program that realizes functions of the evaluation tree generation unit 101, the gold tree generation unit 102, and the tree comparison unit 103.

The evaluation tree generation unit 101 generates the attack tree for the information system which is subject to the attack, based on inference using predicate logic such as Prolog. The attack tree generated by the evaluation tree generation unit 101 is referred to as an evaluation tree. The evaluation tree generation unit 101 generates the evaluation tree by using, for example, the technique of Non-Patent Literature 1 or Non-Patent Literature 2. The evaluation tree includes a plurality of attack paths (hereinafter, also simply referred to as paths) each of which includes a plurality of attack steps.

Besides, the evaluation tree corresponds to a first attack tree. Therefore, the evaluation tree generation unit 101 corresponds to a first attack tree acquisition unit. Further, a process performed by the evaluation tree generation unit 101 corresponds to a first attack tree acquisition process.

The gold tree generation unit 102 generates an attack tree that covers an intrusion route to the information system which is subject to the attack, and reflects an intrusion procedure for the information system. The attack tree generated by the gold tree generation unit 102 is referred to as a gold tree. Like the evaluation tree, the gold tree includes a plurality of attack paths each of which includes a plurality of attack steps.

The gold tree corresponds to a second attack tree. Therefore, the gold tree generation unit 102 corresponds to a second attack tree generation unit. Further, a process performed by the gold tree generation unit 102 corresponds to a second attack tree generation process.

The tree comparison unit 103 compares the evaluation tree with the gold tree. The tree comparison unit 103 outputs a specific attack path to the display 907 when a plurality of attack steps included in the specific attack path which is included in the gold tree, are not included in the evaluation tree in a same order as the gold tree.

A process performed by the tree comparison unit 103 corresponds to a tree comparison process.

Further, as data used by the evaluation tree generation unit 101 and the gold tree generation unit 102 to generate the attack trees, there are system knowledge 104, attack knowledge 105, an initial-stage intrusion template 106, an intrusion procedure template 107, and an intrusion procedure conversion table 108.

The system knowledge 104, the attack knowledge 105, the initial-stage intrusion template 106, the intrusion procedure template 107, and the intrusion procedure conversion table 108 are stored in the main storage device 902 or the auxiliary storage device 903. When the processor 901 operates as the evaluation tree generation unit 101 and the gold tree generation unit 102, the processor 901 reads out the system knowledge 104, the attack knowledge 105, the initial-stage intrusion template 106, the intrusion procedure template 107, and the intrusion procedure conversion table 108.

Details of the system knowledge 104, the attack knowledge 105, the initial-stage intrusion template 106, the intrusion procedure template 107, and the intrusion procedure conversion table 108 will be described later.

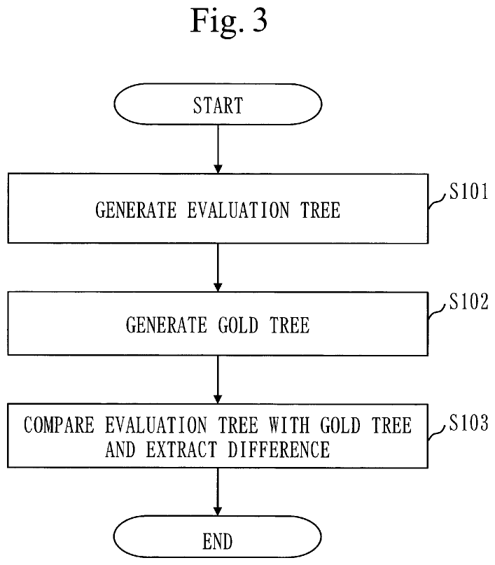

FIG. 3 illustrates an operation example of the coverage evaluation device 100 according to the present embodiment.

An operation example of the coverage evaluation device 100 according to the present embodiment will be described with reference to FIG. 3.

In step S101, the evaluation tree generation unit 101 generates the evaluation tree.

The evaluation tree generation unit 101 generates the evaluation tree based on inference using predicate logic such as Prolog. As described above, the evaluation tree generation unit 101 generates the evaluation tree by using, for example, the technique of Non-Patent Literature 1 or Non-Patent Literature 2.

The inference process is output as a log from attack tree generation technique based on the inference. In Prolog, backward inference is performed, in which a search is conducted by a recursive procedure as to whether or not a given proposition (attack goal) is satisfied. A log of the inference process is a log which describes a successful rule and an unsuccessful rule in the backward inference.

In the coverage evaluation device 100, knowledge (network configuration, vulnerable location, preconditions of an attacker) expressing the information system which is subject to the attack, and inference rule, are prepared in advance.

Specifically, the system knowledge 104 illustrated in FIG. 2 is prepared in the coverage evaluation device 100 as the knowledge expressing the information system which is subject the attack.

Knowledge about a network configuration of the information system which is subject to the attack in the system knowledge 104 indicates the network configuration of the information system. Therefore, the knowledge corresponds to the network configuration information.

Further, as the inference rule, the attack knowledge 105, the initial-stage intrusion template 106, and the intrusion procedure template 107 illustrated in FIG. 2 are prepared in the coverage evaluation device 100.

In addition, the initial-stage intrusion template 106 and the intrusion procedure template 107 indicate the intrusion procedure of the attack. Therefore, the initial-stage intrusion template 106 and the intrusion procedure template 107 correspond to intrusion procedure information.

When an attack goal is input to the evaluation tree generation unit 101, the evaluation tree generation unit 101 derives, by the backward inference, all cases (attack paths) in which the attack goal is satisfied, by utilizing the knowledge and the inference rule described above. Then, the evaluation tree generation unit 101 generates the evaluation tree by connecting all the attack paths.

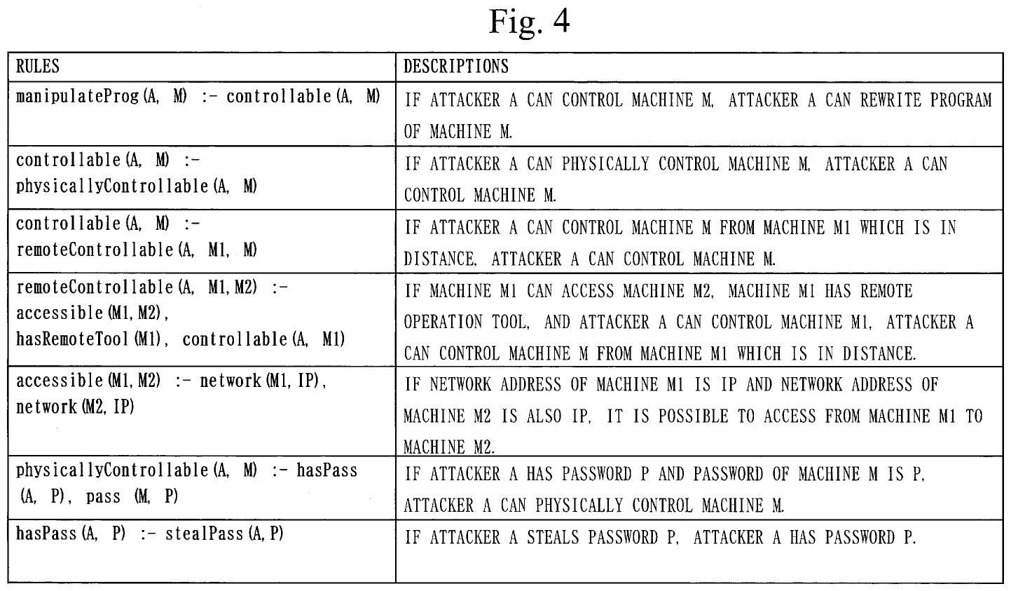

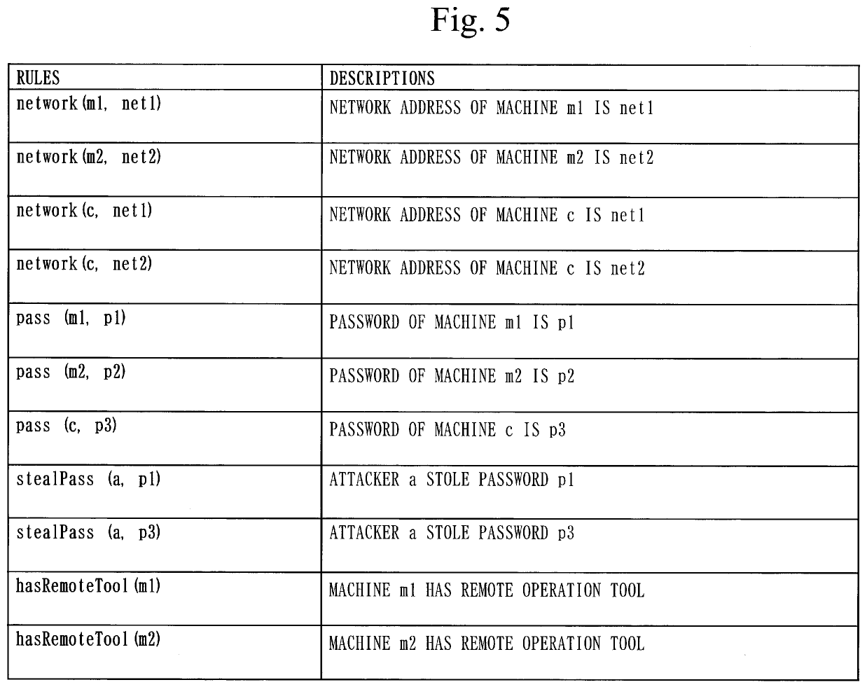

The knowledge and the rule required to generate the attack tree will be described with reference to FIGS. 4 and 5.

FIG. 4 illustrates an example of the attack knowledge 105. FIG. 5 illustrates an example of the system knowledge 104.

FIGS. 4 and 5 are illustrated according to a notation method of Prolog, however a notation method is not limited to the method illustrated in FIGS. 4 and 5.

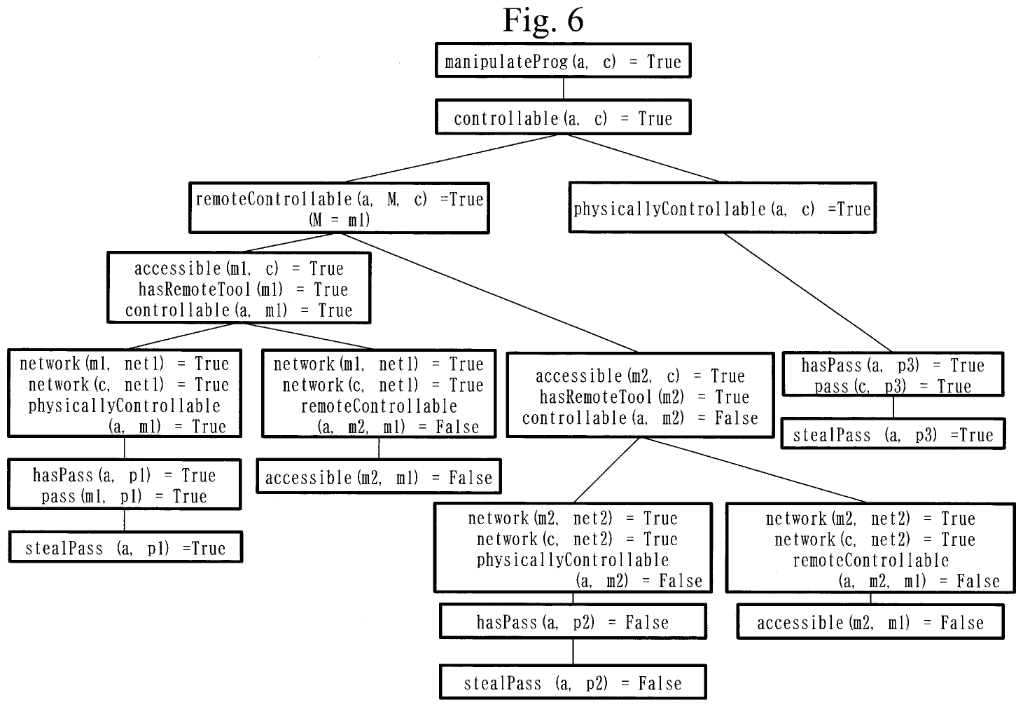

When the attack knowledge 105 and the system knowledge 104 are input to the evaluation tree generation unit 101 and a question “manipulateProg (a, c) (an attacker a can rewrite a program of a machine c)” is asked, the inference process of the Prolog can be expressed by a tree as in FIG. 6. In FIG. 6, descriptions of process of inference failure are stopped at a stage when a goal written on a body part fails for a first time.

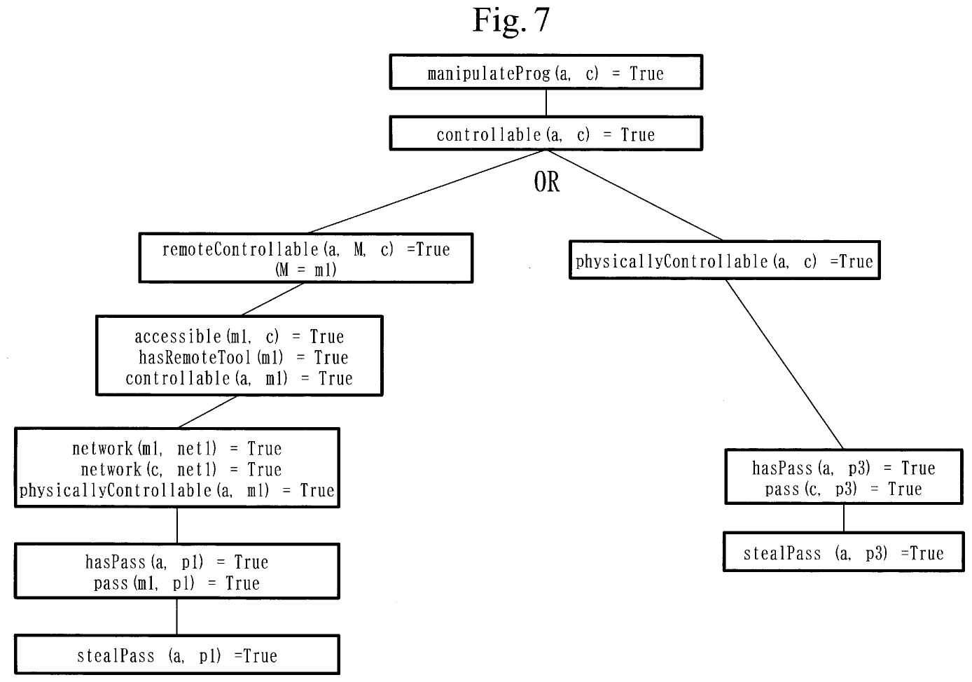

When “manipulateProg (a, c)” is true (satisfied), the backward inference in which a search is conducted by the recursive procedure is performed. If selecting only paths about which inference succeeds from the tree in FIG. 6, the tree in FIG. 7 is obtained. The evaluation tree is generated through such a procedure.

In a case of the tree in FIG. 7, two attack paths are inferred. A first path is a path extending from a lower left node in FIG. 7. That is, the first path is “The attacker a steals a password p1” (stealPass(a,p1)=True), “The attacker a has the password p1 of a machine m1” (hasPass(a,p1)=True pass(m1,p1)=True), “Network addresses of the machine m1 and the machine c are the same, and the attacker a can physically control the machine m1”(network(m1,net1)=True network(c,net1)=True physicallyControllable(a,m1)=True), “The machine m1 can physically access the machine c, the machine m1 has a remote control tool, and the machine m1 can be controlled by the attacker”(accessible(m1,c)=True hasRemoteTool(m1)=True controllable (a, m1)=True), “The attacker a can control the machine c from the machine m1 which is in the distance” (remoteControllable(a, M, C)=True (M=m1)), “The attacker a can control the machine c” (controllable (a, c)=True), and “The attacker a can rewrite the program of the machine c” (manipulateProg (a, c)=True).

A second path is a path extending from a lower right node in FIG. 7. That is, the second path is “The attacker a steals the password p3” (stealPass(a,p3)=True), “The attacker a has the password p3 of the machine c” (hasPass(a,p3))=True pass(c,p3)=True), “The attacker a can physically control the machine c” (physicallyControllable(a,c)=True), “The attacker a can control the machine c” (controllable(a,c)=True), and “The attacker a can rewrite the program of the machine c”(manipulateProg(a,c)=True).

Next, in step S102, the gold tree generation unit 102 generates the gold tree.

More specifically, the gold tree generation unit 102 lists the incursion routes in the network in a brute force manner based on the system knowledge 104. Then, the gold tree generation unit 102 utilizes the initial-stage intrusion template 106 and the intrusion procedure template 107 to generate the gold tree that covers the intrusion routes to the information system and reflects the intrusion procedures for the information system.

Finally, in step S103, the tree comparison unit 103 compares the evaluation tree with the gold tree and extracts the difference.

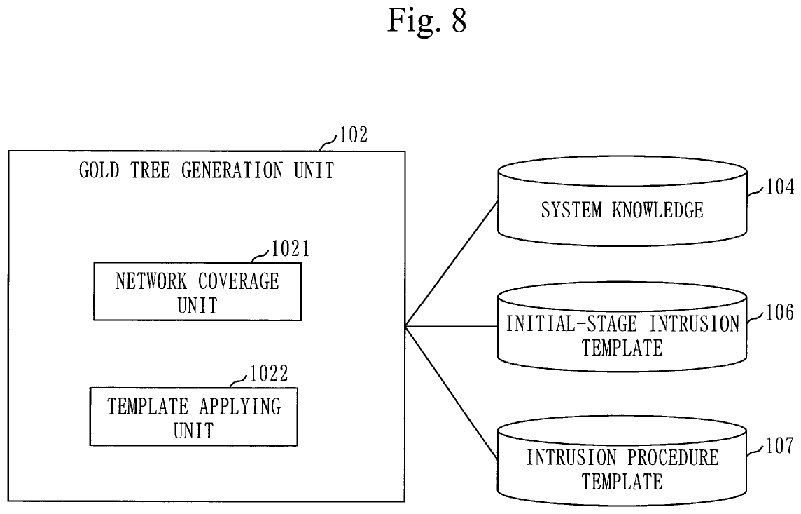

FIG. 8 illustrates the internal configuration example of the gold tree generation unit 102.

As illustrated in FIG. 8, the gold tree generation unit 102 is configured by a network coverage unit 1021 and a template applying unit 1022. In addition, the gold tree generation unit 102 generates the gold tree by using the system knowledge 104, the initial-stage intrusion template 106, and the intrusion procedure template 107.

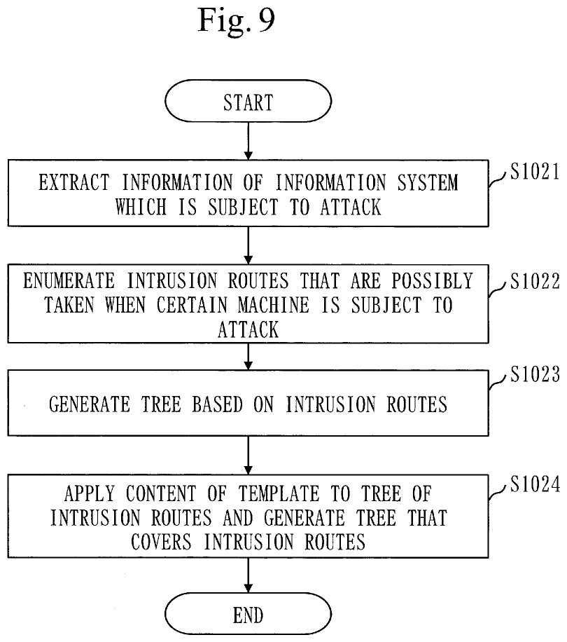

FIG. 9 illustrates an operation example of the gold tree generation unit 102.

First, in step S1021, the network coverage unit 1021 extracts information (a network configuration, a vulnerable location, attacker's preconditions) of the information system which is subject to the attack, from the system knowledge 104. The system knowledge 104 is configured in a mechanically readable format such as, for example, an XML format in order for the evaluation tree generation unit 101 to derive the attack path based on the inference. The network coverage unit 1021 extracts information about all machines existing in the information system which is subject to the attack.

Next, in step S1022, the network coverage unit 1021 enumerates, including no redundancy, all the possible intrusion routes to a certain machine in the information system, when the machine is subject to the attack. The system knowledge 104 includes information of the network configuration of the information system. The network coverage unit 1021 can extract a logically and physically consistent intrusion route by using the network configuration of the information system.

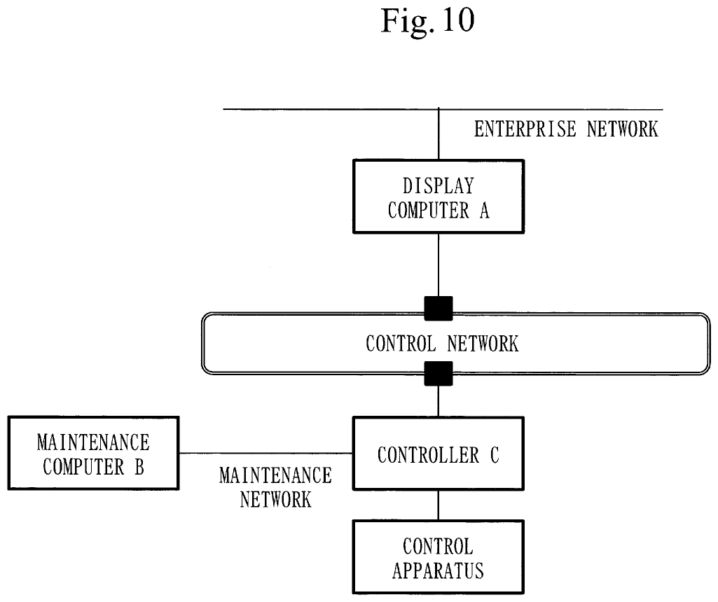

FIG. 10 illustrates a simplified network configuration of a control system as an example of the network configuration of the information system.

In the control system in FIG. 10, a controller C that controls a control apparatus is connected to a control network and a maintenance network. A maintenance computer B that maintains the controller C is connected to the maintenance network. The controller C and a display computer A for displaying which monitors the controller C and the control network are connected to the control network. Hereinafter, the display computer A, the maintenance computer B, and the controller C are also simply written as A, B, and C, respectively.

In the example in FIG. 10, “A, B, and C” is a machine list. When a machine which is subject to the attack is assumed to be the controller C, all the possible intrusion routes to the controller C, without considering the network configuration and without including any redundancy, are “C, CB, CBA, CA, and CAB”. The number of logical routes is “1+₂P₁+₂P₂” (P means permutation). Among the above “C, CB, CBA, CA, and CAB”, “C” itself means that the attacker directly manipulates and attacks the controller C. “CB” means that the attacker directly manipulates the maintenance computer B to intrude into the controller C and attack the controller C. “CBA” means that the attacker directly manipulates the display computer A to intrude into the maintenance computer B, further intrudes into the controller C, and attacks the controller C. The same applies to “CA” and “CAB”.

When the network configuration is considered and routes that are clearly inconsistent logically and physically are removed, a combination of intrusion routes becomes “C, CB, and CA”.

Next, in step S1023, the network coverage unit 1021 aggregates the extracted intrusion routes and generates a tree covering the intrusion routes.

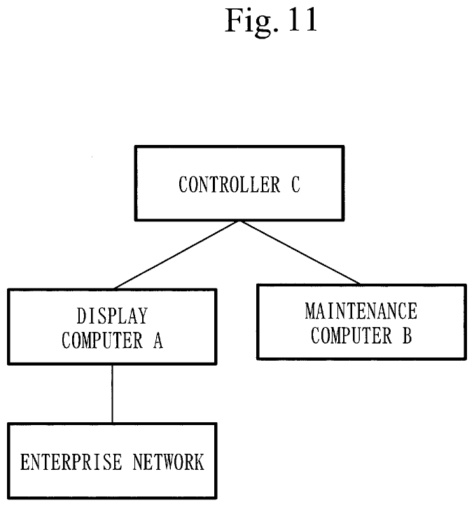

In a case of the control system in FIG. 10, if the network configuration is considered, the tree covering the intrusion routes is as illustrated in FIG. 11. In the present embodiment, regardless of a hierarchical position of each node (regardless of whether each node is a terminal node or an intermediate node), it is assumed that the attacker directly manipulates each node to intrude into a parent node. Note that, in FIG. 11, for convenience, a node of an enterprise network is arranged under the display computer A.

Next, in step S1024, the template applying unit 1022 utilizes the initial-stage intrusion template 106 and the intrusion procedure template 107 to generate a tree that reflects the intrusion procedure.

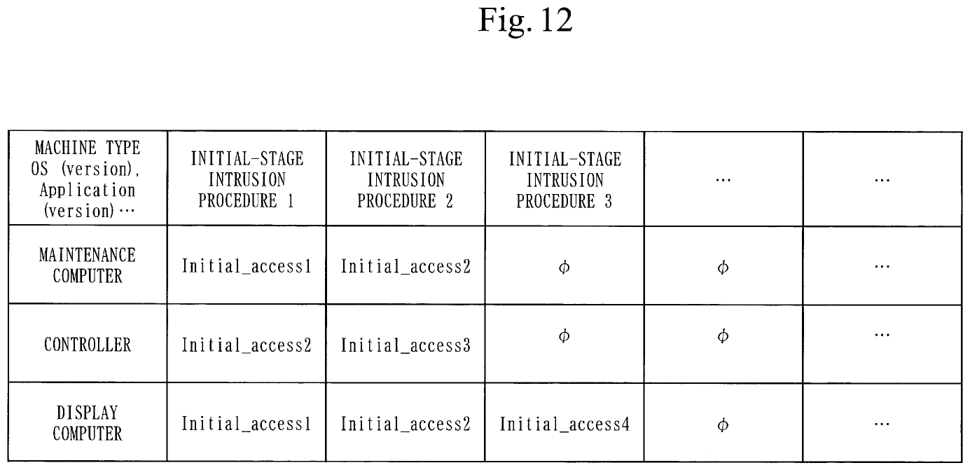

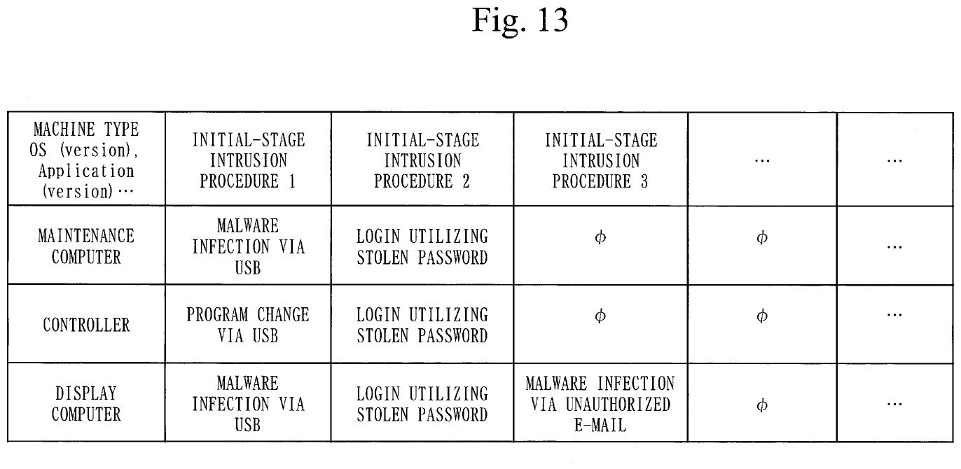

FIG. 12 illustrates an example of the initial-stage intrusion template 106. In the initial-stage intrusion, procedures such as login using a stolen password and malware infection via a USB memory can be considered. FIG. 13 illustrates an example of the initial-stage intrusion template 106 in which specific procedures are described.

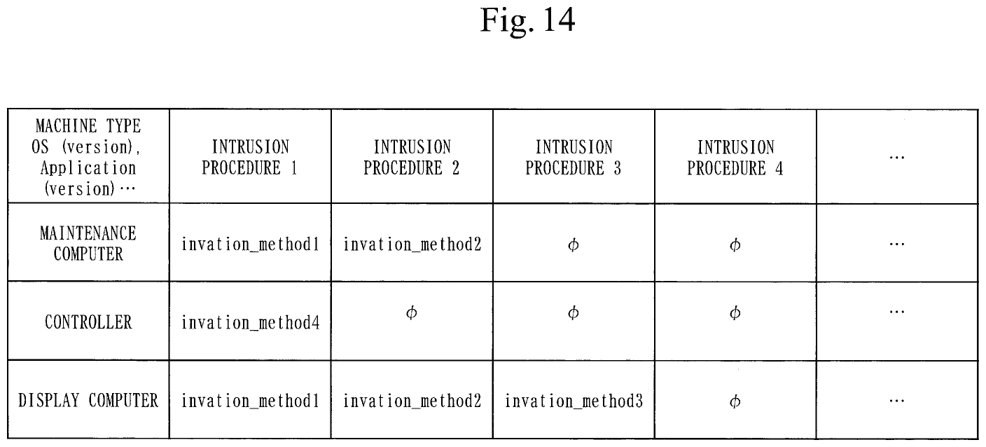

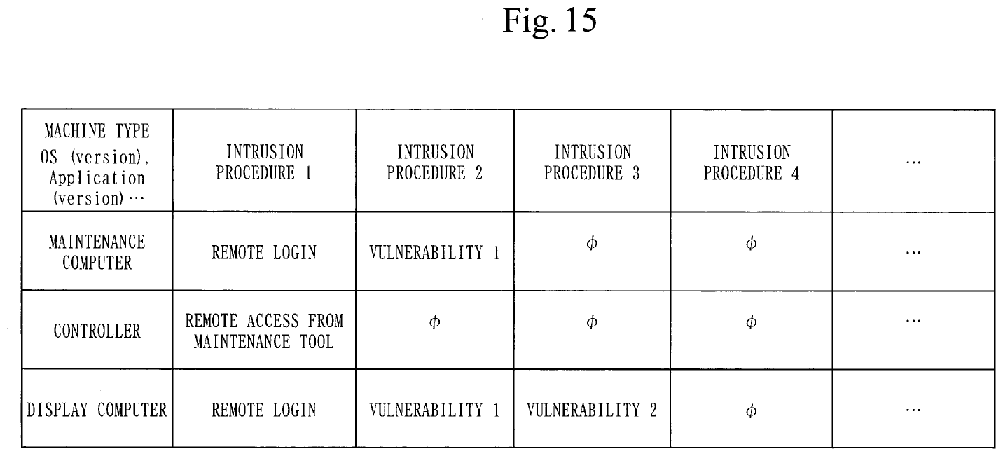

FIG. 14 illustrates an example of the intrusion procedure template 107. The intrusion procedure template 107 is a table in which the intrusion procedures are enumerated for each machine type. An execution of an arbitrary program following a buffer overflow, a remote desktop connection by a stolen password and the like are the procedures of the intrusion. If there exist a plurality of networks between two machines, the intrusion procedure may be enumerated in the intrusion procedure template 107 for each network type in addition to the machine type. FIG. 15 illustrates an example of the intrusion procedure template 107 in which specific procedures are described.

The procedures described in the intrusion procedure template 107 and the initial-stage intrusion template 106 can be extracted from formalized public databases such as Reference 1 and Reference 2, and utilized.

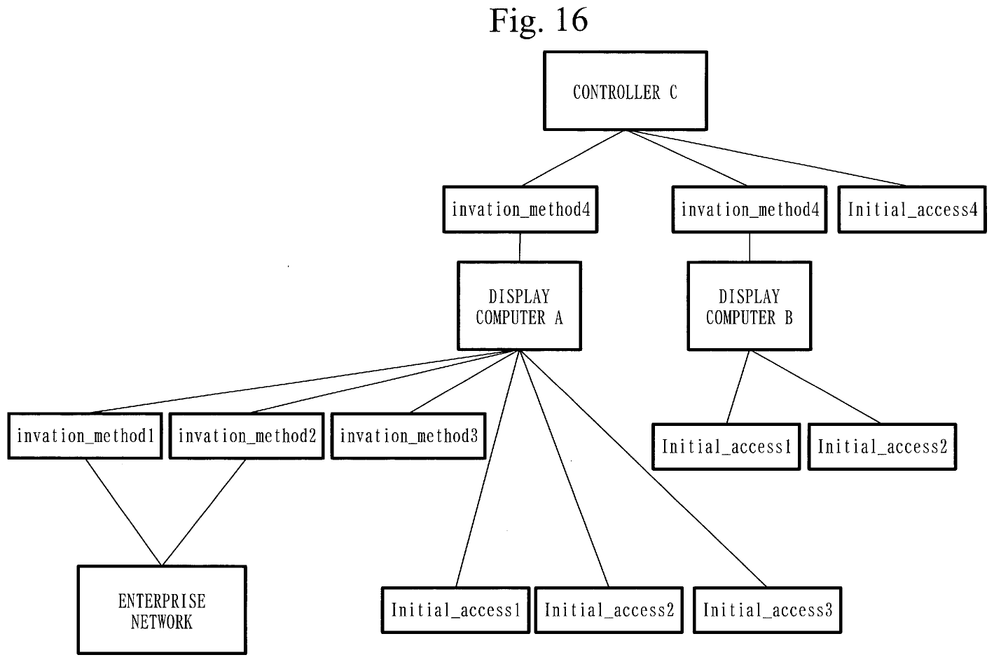

FIG. 16 illustrates a tree after applying the initial-stage intrusion template 106 in FIG. 13 and the intrusion procedure template 107 in FIG. 15 to the tree in FIG. 11.

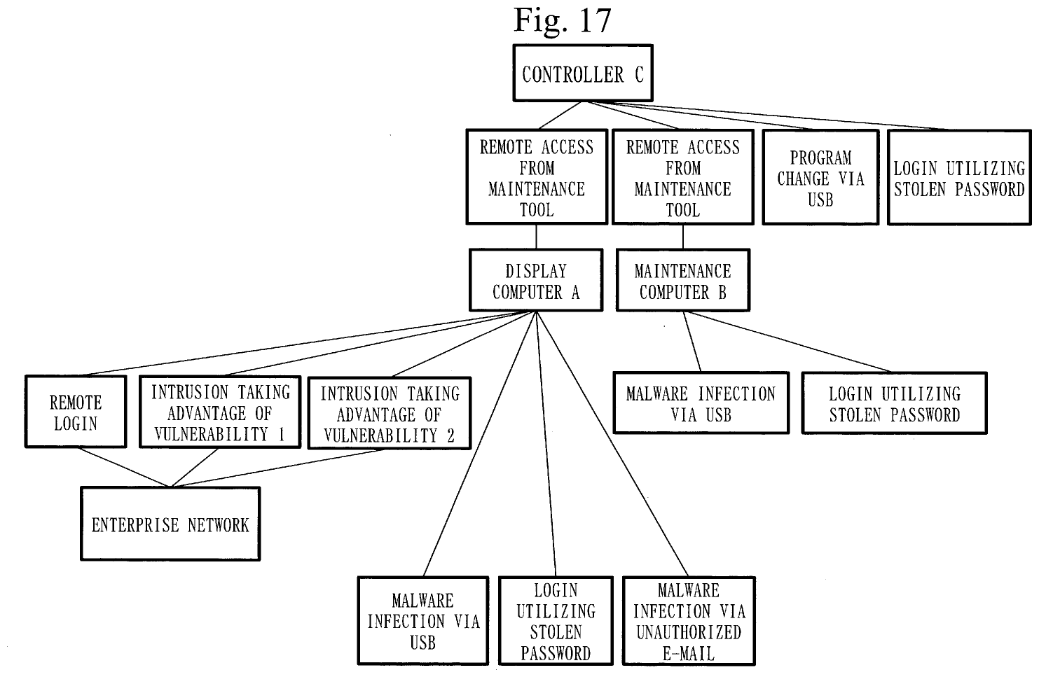

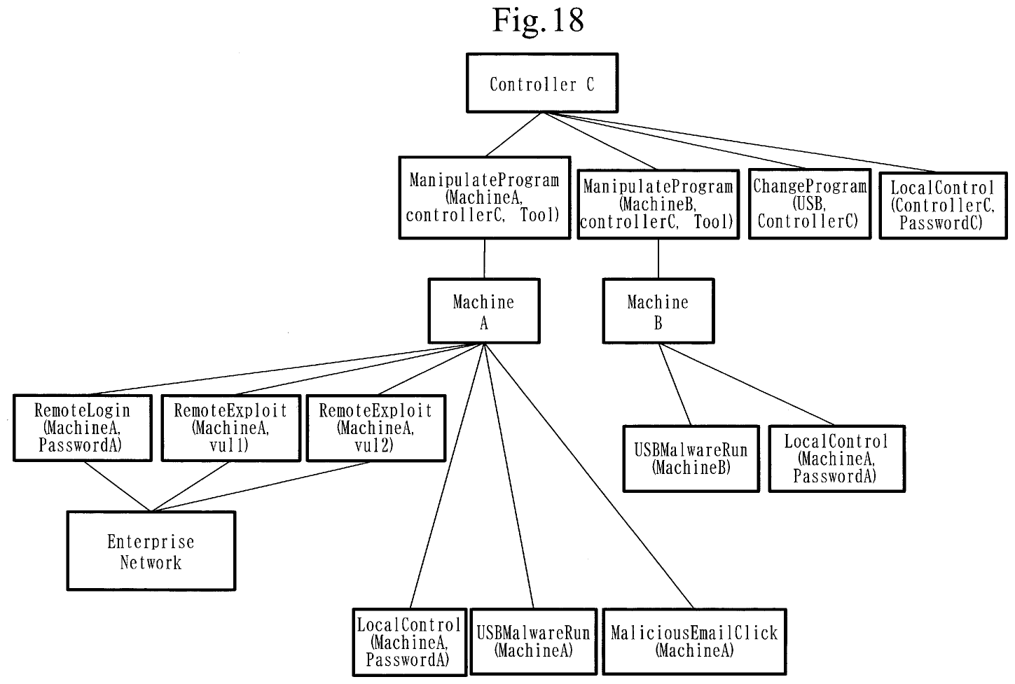

In addition, FIG. 17 illustrates a tree in which specific procedures are described. Further, FIG. 18 illustrates an example of a tree in which the descriptions in FIG. 17 are changed to machine-readable descriptions. In FIG. 18, the “display computer A” is described as “Machine A”, and the “maintenance computer B” is described as “Machine B”.

Note that, FIG. 18 corresponds to the gold tree.

Reference 1: MITER, ATT&CK, https://attack.mitre.org/wiki/ Main Page

Reference 2: CAPEC, http://capec.mitre.org/index.html

Besides, it is also possible to specify all the nodes in the control system to be subject to the attack and generate the gold tree for each node. However, since it is inefficient, in the present embodiment, the gold tree generation unit 102 generates a gold tree by specifying only a machine described in a node at a top of the evaluation tree, to be subject to the attack.

The same intrusion procedure template 107 and the same initial-stage intrusion template 106 may be used for all machines. Further, the intrusion procedure template 107 and the initial-stage intrusion template 106 may be prepared for each type of machines such as a standard PC (Personal Computer), a server, and a controller. Further, the intrusion procedure template 107 and the initial-stage intrusion template 106 may be prepared for each version of an OS (Operating System) or an application program installed on the machine.

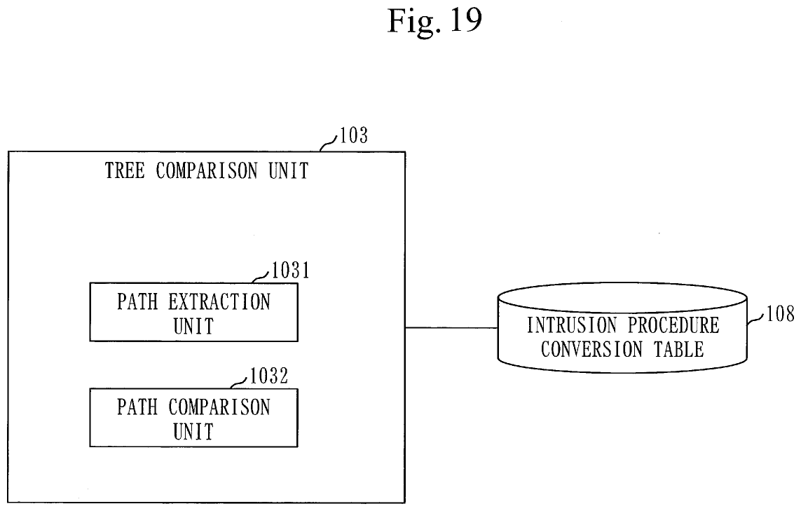

FIG. 19 illustrates an internal configuration example of the tree comparison unit 103.

As illustrated in FIG. 19, the tree comparison unit 103 is configured by a path extraction unit 1031 and a path comparison unit 1032. Further, the tree comparison unit 103 refers to the intrusion procedure conversion table 108.

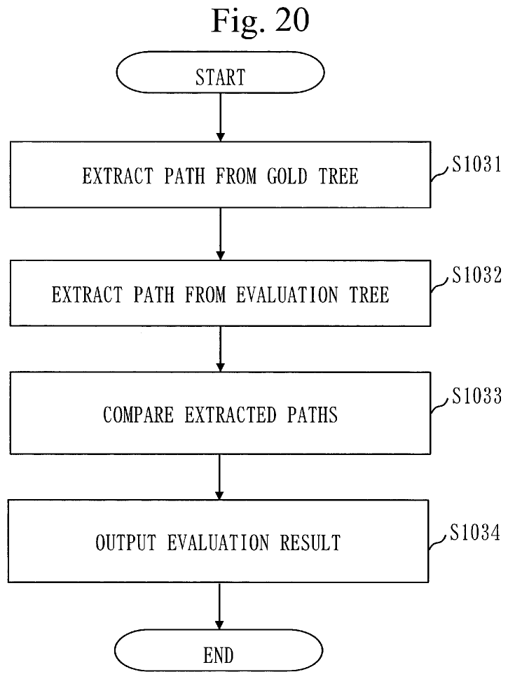

FIG. 20 illustrates an operation example of the tree comparison unit 103.

First, in step S1031, the path extraction unit 1031 extracts a path from the gold tree. The path extraction unit 1031 extracts the path by finding parent nodes from a leaf node to a root node in the gold tree. Ten paths shown below are extracted from the gold tree in FIG. 18. Note that, in the following, descriptions in FIG. 18 are partially omitted.

1) remoteLogin(_,machineA,passwordA)⇒manipulateProgram(machineA,controllerC,tool)
2) remoteExploit(_,machineA,vul1)⇒manipulateProgram(machineA,controllerC,tool)
3) remoteExploit(_,machineA,Vul2)⇒manipulateProgram(machineA,controllerC,tool)
4) localControl(_,machineA,passwordA)⇒manipulateProgram(machineA,controllerC,tool)
5) usbMalwareRun(_,machineA,_)⇒manipulateProgram(machineA,controllerC,tool)
6) maliciousEmailClick(_,machineA)⇒manipulateProgram(machineA,controllerC,tool)
7) usbMalwareRun(_,machineB)⇒manipulateProgram(machineB,controllerC,tool)
8) localControl(_,machineB,passwordB)⇒manipulateProgram(machineB,controllerC,tool)
9) changeProgram(_,controllerC,usb)
10) localControl(_,controllerC,passwordC)

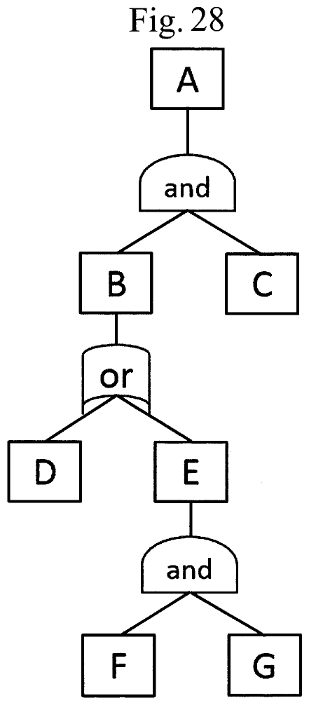

Next, in step S1032, the path extraction unit 1031 extracts a path from the evaluation tree. The path extraction unit 1031 extracts the path by finding parent nodes from a leaf node to a root node in the evaluation tree. Note that, although the evaluation tree according to the present embodiment is configured only by OR nodes, the evaluation tree may include AND nodes. In this case, the path extraction unit 1031 extracts the paths of all of combinations of sequences, for child nodes (AND conditions) connected to the AND nodes. For example, in an example in FIG. 28, six paths shown below are extracted. The path extraction unit 1031 extracts all paths, by recursively obtaining the path from each node toward the terminal node and changing a connection pattern of the path with the parent node according to the relationship with the parent node (OR or AND).

### 1) A→B→D→C

### 2) A→B→E→F→G→C

### 3) A→B→E→G→F→C

### 4) A→C→B→D

### 5) A→C→B→E→F→G

### 6) A→C→B→E→G→F

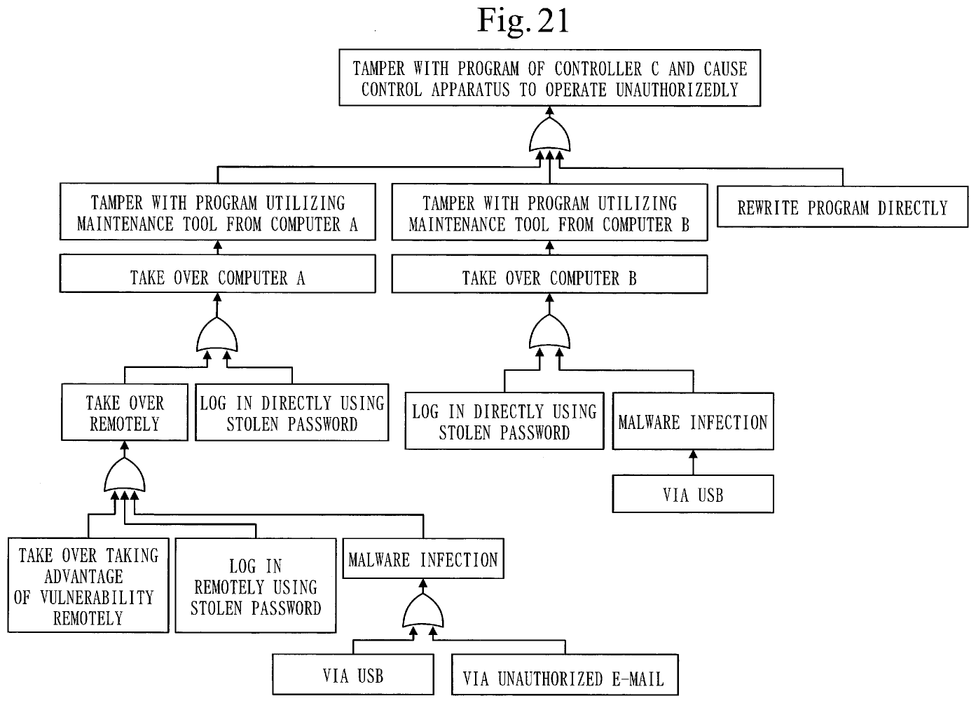

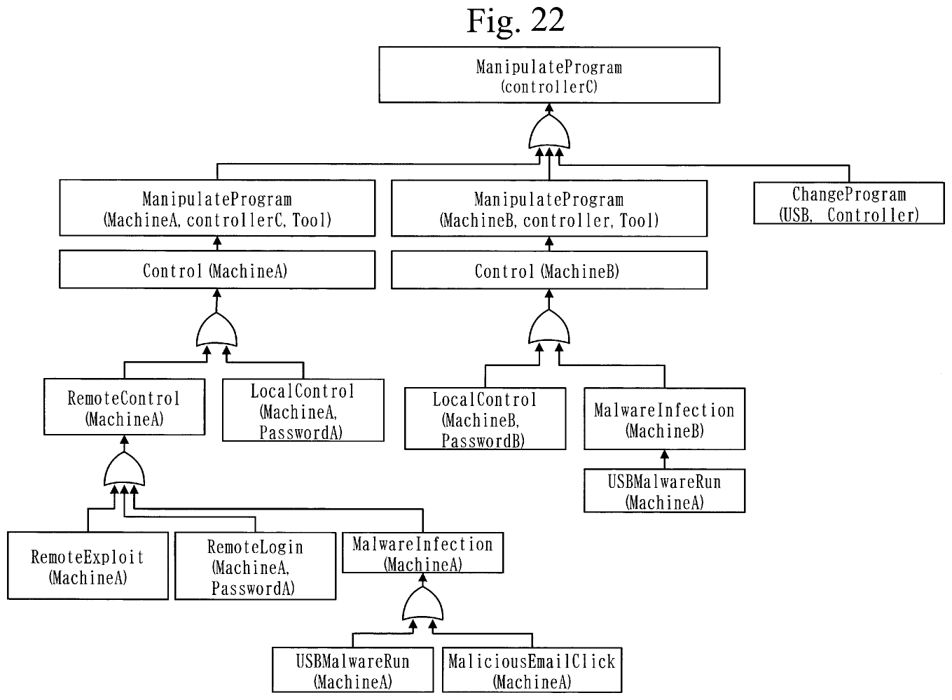

It is assumed that the evaluation tree generation unit 101 generates the evaluation tree illustrated in FIG. 21 for the control system in FIG. 10. A tree in which the descriptions in FIG. 21 are changed in such a way to conform to a description format in FIG. 18 is illustrated in FIG. 22, for easier comparison with the gold tree. Seven paths shown below are extracted from the evaluation tree in FIG. 22. Note that, in the following, descriptions in FIG. 22 are partially omitted. In addition, descriptions about detailed conditions and rules for a successful attack are also omitted.

A) remoteExploit(_,machineA,vul1)⇒remoteControl(_,machineA,_)⇒control(_, machineA,_)⇒manipulateProgram(machineA,controllerC,Tool)⇒manipulateProgram(_, controllerC,_)
B) remoteLogin(_,machineA,passwordA)⇒remoteControl(_,machineA,_) ⇒control(_,machineA,_)⇒manipulateProgram(machineA,controllerC,tool)manipulate Program(_,controllerC,_)
C) usbMalwareRun(_,machineA,_)⇒malwareInfection(_,machineA,_)⇒remoteControl(_,machineA,_)⇒control(_,machineA,_)⇒manipulateProgram(machineA ,controllerC,tool)⇒manipulateProgram(_,controllerC,_)
D) maliciousEmailClick(_,machineA,_)⇒malwareInfection(_,machineA,_) ⇒remoteControl(_,machineA,_)⇒control(_,machineA,_)⇒manipulateProgram (machineA,controllerC,tool)⇒manipulateProgram(_,controllerC,_)
E) localControl(_,machineB,passwordB)⇒control(_,machineB,_)⇒manipulateProgram(machineB,controllerC,tool)⇒manipulateProgram(_,controllerC,_)
F) usbMalwareRun(_,machineB,_)⇒malwareInfection(_,machineB,_)⇒control(_,machineB,_)⇒manipulateProgram(machineB,controllerC,tool)⇒manipulateProgram(_,controllerC,_)
G) changeProgram(_,controllerC,usb)⇒manipulateProgram(_,controllerC,_)

In step S1033, the path comparison unit 1032 compares the paths extracted from each of the gold tree and the evaluation tree. Then, the path comparison unit 1032 extracts from the evaluation tree, a path that always includes an attack step that is included in the path of the gold tree.

For explanation, the attack step of the attack path extracted from the gold tree is indicated as gStep (members are a, nf, nt, i, s). An attack step gStep means that a subject gStep.s utilizes an intrusion procedure gStep.a, and uses supplementary information gStep.i to attack an attack destination node gStep.nt from an attack source node gStep.nf.

In a case of malEmailClick (m1,x, ,), gStep.a is malEmailClick. gStep.nf is x. gStep.nt is m1. gStep.i is “ ” (don't care). gStep.s is “ ” (don't care).

Similarly, the attack step of the attack path extracted from the evaluation tree is indicated as aStep (members are a, nf, nt, i, s). The attack step aStep means that the subject aStep.s utilizes an intrusion procedure aStep.a and uses supplementary information aStep.i to attack the attack destination node aStep.nt from the attack source node aStep.nf.

In a case of remExp (a,x,m1,vul1), aStep.a is remExp. aStep.s is a. aStep.nf is x. aStep.nt is m1. aStep.i is vul1.

A plurality of intrusion procedures (or conditions) may be included in one attack step, such as “access(x, m1, , _), clickMalEmail1(a,x,m1, _), control(a,x, _, _)”. Such attack steps are treated as a set of intrusion procedures, regardless of the number of elements.

Each attack path extracted from the gold tree is an order list whose elements are the attack steps (intrusion procedures). Each attack path extracted from the evaluation tree is an order list whose elements are the attack steps (a set of intrusion procedures). The path comparison unit 1032 compares the attack path of the gold tree with the attack path of the evaluation tree as follows.

The path comparison unit 1032 picks up an attack path extracted from the gold tree one by one, and further picks up an attack path extracted from the evaluation tree one by one.

Next, the path comparison unit 1032 searches the evaluation tree for an attack path that includes all elements (intrusion procedures) in a proper order, that are included in the attack path of the gold tree. Each element of the attack path in the evaluation tree is expressed using a set of intrusion procedures. Therefore, the path comparison unit 1032 determines whether or not the intrusion procedure of the attack step of the gold tree is included in the set of intrusion procedures of the evaluation tree.

For a case in which formats of the intrusion procedures (incursion approach and intrusion approach) utilized in the gold tree and the evaluation tree are different (for example, malEmailClick (x,m1) and clickMalEmaill (a,x,m1)), the intrusion procedure conversion table 108 is prepared so that a correspondence between the intrusion procedures can be obtained.

Each intrusion approach is tagged with an identifier of the attack approach such as CAPEC or ATT&CK in advance.

In the intrusion procedure conversion table 108, the corresponding identifier (CAPEC or ATT&CK) is described in addition to a corresponding attack approach name, a corresponding subject, corresponding supplementary information, a corresponding attack source node, and a corresponding attack destination node.

The path comparison unit 1032 compares the attack path of the gold tree with the attack path of the evaluation tree, thereby, the attack path of the evaluation tree corresponding to the attack path of the gold tree is output in a dictionary format. Such a comparison operation by the path comparison unit 1032 is referred to as matchedAttackPathDict.

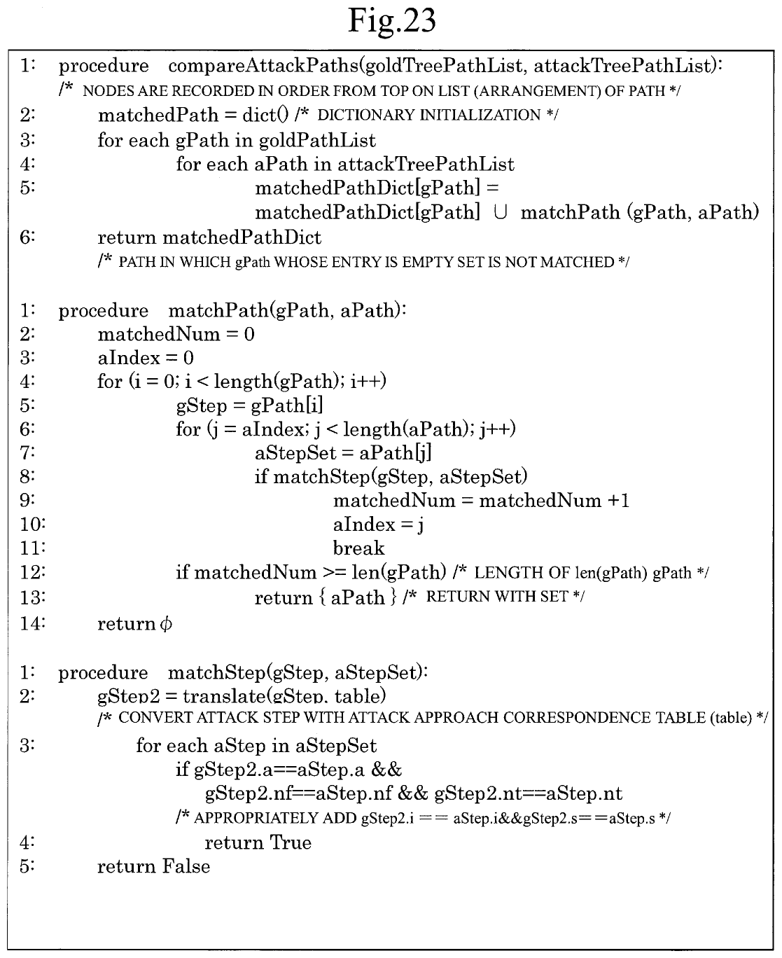

FIG. 23 illustrates a pseudo code (compareAttackPaths) that realizes the comparison operation by the path comparison unit 1032.

Each entry (gPath) that is an empty set (φ) in matchedAttackPathDict is a difference (an attack path included in the gold tree but not included in the evaluation tree) desired to be obtained.

Finally, in step S1034, the path comparison unit 1032 outputs an evaluation result.

For example, when there exists a path that is not covered by the evaluation tree, the path comparison unit 1032 displays on the display 907, the path that is not covered by the evaluation tree. The user of the coverage evaluation device 100 can analyze the path displayed on the display 907 to revise the system knowledge 104, the attack knowledge 105, or the like, and can improve the coverage of the evaluation path.

### Description of Effect of Embodiment

In the present embodiment, since the evaluation tree is compared with the gold tree that covers the intrusion routes to the information system and reflects the intrusion procedures for the information system, it is possible to evaluate the coverage of the evaluation tree. Further, in the present embodiment, it is possible to extract a path that is not covered by the evaluation tree, and present the extracted path to the user of the coverage evaluation device 100. Therefore, the user can give a feedback of presented contents to the generation procedure of the evaluation tree, and as a result, it is possible to improve the coverage of the evaluation tree.

### Second Embodiment

In the first embodiment, when a path that is not covered by the evaluation tree is extracted, the extracted path is only presented to the user. In the present embodiment, a configuration will be described which indicates a reason why a path is not covered by the evaluation tree when the path that is not covered by the evaluation tree is extracted.

### Description of Configuration

Also in the present embodiment, a hardware configuration example of the coverage evaluation device 100 is as illustrated in FIG. 1. Further, a functional configuration example of the coverage evaluation device 100 is as illustrated in FIG. 2.

In the present embodiment, an internal configuration example of the tree comparison unit 103 is different from that of the first embodiment.

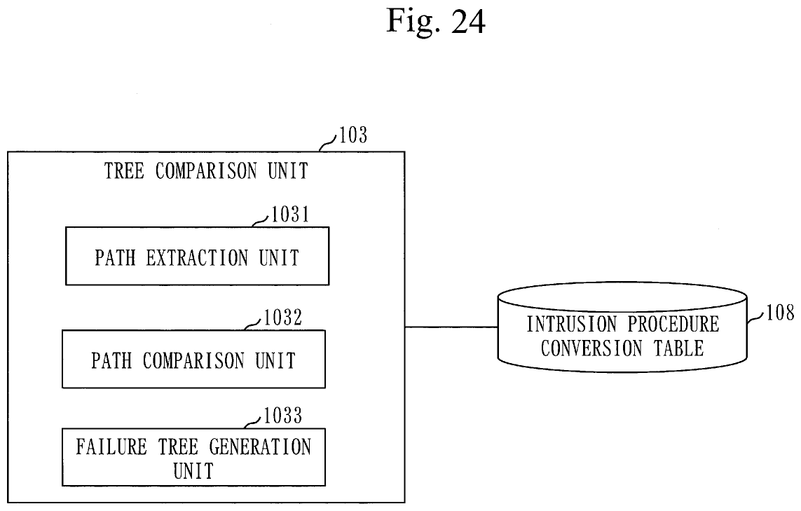

FIG. 24 illustrates the internal configuration example of the tree comparison unit 103 according to the present embodiment.

In FIG. 24, a failure tree generation unit 1033 is added as compared with the configuration in FIG. 19.

The failure tree generation unit 1033 generates an attack tree including elements for which inference is failed in the inference using predicate logic for the information system. That is, the failure tree generation unit 1033 generates an attack tree configured by paths for which the inference is failed in the generation of the evaluation tree by the evaluation tree generation unit 101. The attack tree generated by the failure tree generation unit 1033 is referred to as a failure tree. As with the evaluation tree, the failure tree includes a plurality of attack paths each of which includes a plurality of attack steps.

The failure tree generation unit 1033 corresponds to a failure tree acquisition unit.

In the present embodiment, the path extraction unit 1031 extracts the path also from the failure tree.

Further, in the present embodiment, the path comparison unit 1032 compares the evaluation tree with the gold tree, and also compares the gold tree with the failure tree.

Then, when a plurality of attack steps included in a specific attack path included in the gold tree are not included in either the evaluation tree or the failure tree in a same order as the gold tree, the path comparison unit 1032 outputs the specific attack path to the display 907. Further, the path comparison unit 1032 outputs to the display 907, a message notifying that a premise of the inference using the predicate logic, that is, the system knowledge 104, the attack knowledge 105, or the like, is assumed to have a defect.

Further, also when a plurality of attack steps included in a specific attack path included in the gold tree are not included in the evaluation tree in the same order as the gold tree, but are included in the failure tree, the path comparison unit 1032 outputs the specific attack path to the display 907. Further, the path comparison unit 1032 outputs a message to the display 907 notifying that the premise of the inference using the predicate logic, that is, the system knowledge 104, the attack knowledge 105, or the like, is assumed to have no defect.

### Description of Operation

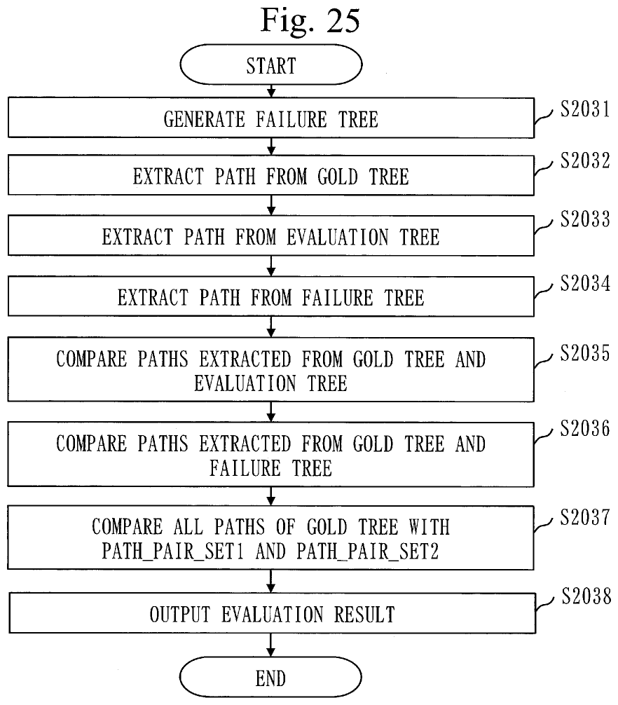

FIG. 25 illustrates an operation example of the tree comparison unit 103 according to the present embodiment.

First, in step S2031, the failure tree generation unit 1033 generates the failure tree.

By modifying a process of the evaluation tree generation unit 101, it is possible to realize the failure tree generation unit 1033. The evaluation tree generation unit 101 utilizes the system knowledge 104, the attack knowledge 105, or the like to derive all cases (attack paths) in which an attack goal is satisfied, using backward inference. The evaluation tree generation unit 101 can extract the attack tree in FIG. 7 through an inference process in FIG. 6 when utilizing the attack knowledge 105 and the system knowledge 104 described in FIGS. 4 and 5. Here, the inference process in FIG. 6 also includes the process of an inference failure. Therefore, the failure tree generation unit 1033 can obtain the failure tree by selecting only a path in which the inference has failed. Specifically, the evaluation tree generation unit 101 divides each inference process that is True. Further, the evaluation tree generation unit 101 excludes an inference process that is Fail. By doing so, the evaluation tree generation unit 101 generates the evaluation tree. On the other hand, the failure tree generation unit 1033 does not divide each inference process that is True, but divides each inference process that is Fail. Then, the failure tree generation unit 1033 excludes the inference process that is True.

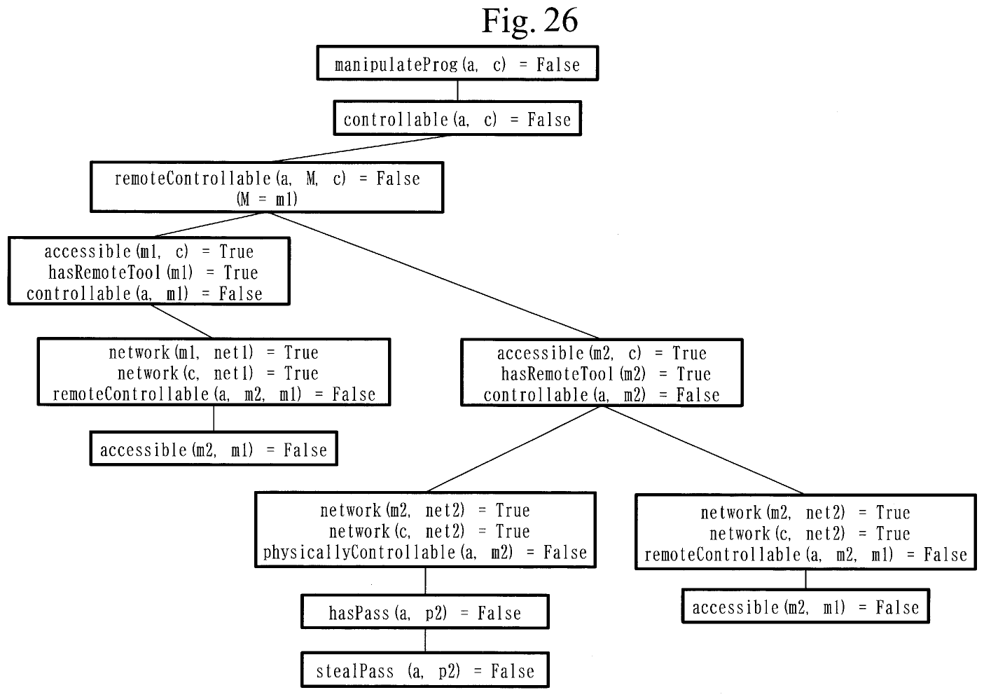

FIG. 26 illustrates an example of the failure tree in which only the failure paths are picked up from the tree in FIG. 6 and shaped. The failure tree generation unit 1033 ends the process when it is found for the first time that pickup of the failure path fails (the condition becomes False). Combining the evaluation tree in FIG. 7 and the failure tree in FIG. 26 generates the tree in FIG. 6, and it is understood that the evaluation tree and the failure tree are complementary.

In steps S2032 and S2033, the path extraction unit 1031 extracts paths from the gold tree and the evaluation tree. Since steps S2032 and S2033 are the same as steps S1031 and S1032 described in the first embodiment, detailed descriptions will be omitted.

Next, in step S2034, the path extraction unit 1031 extracts the path from the failure tree. Since the process of step S2034 is the same as those of steps S2032 and S2033, detailed descriptions will be omitted.

Next, in step S2035, the path comparison unit 1032 compares the paths extracted from each of the gold tree and the evaluation tree. Then, the path comparison unit 1032 utilizes the comparison procedure illustrated in FIG. 23 to acquire matchedAttackPathDict as a comparison result.

Next, in step S2036, the path comparison unit 1032 compares the paths extracted from each of the gold tree and the failure tree in the same manner. A procedure of step S2036 is basically the same as that of step S2035. However, step S2036 is different in that an attack path of the failure tree that matches an attack path of the gold tree halfway may be compared with the attack path of the gold tree. The attack step of the attack path of the failure tree is indicated as fStep (members are a, nf, nt, i, s). The path comparison unit 1032 compares the attack path of the gold tree with the attack path of the failure tree, thereby, the attack path of the failure tree corresponding to the attack path of the gold tree is output in a dictionary format. Such a comparison operation of the path comparison unit 1032 is referred to as matchedFailedAttackPathDict.

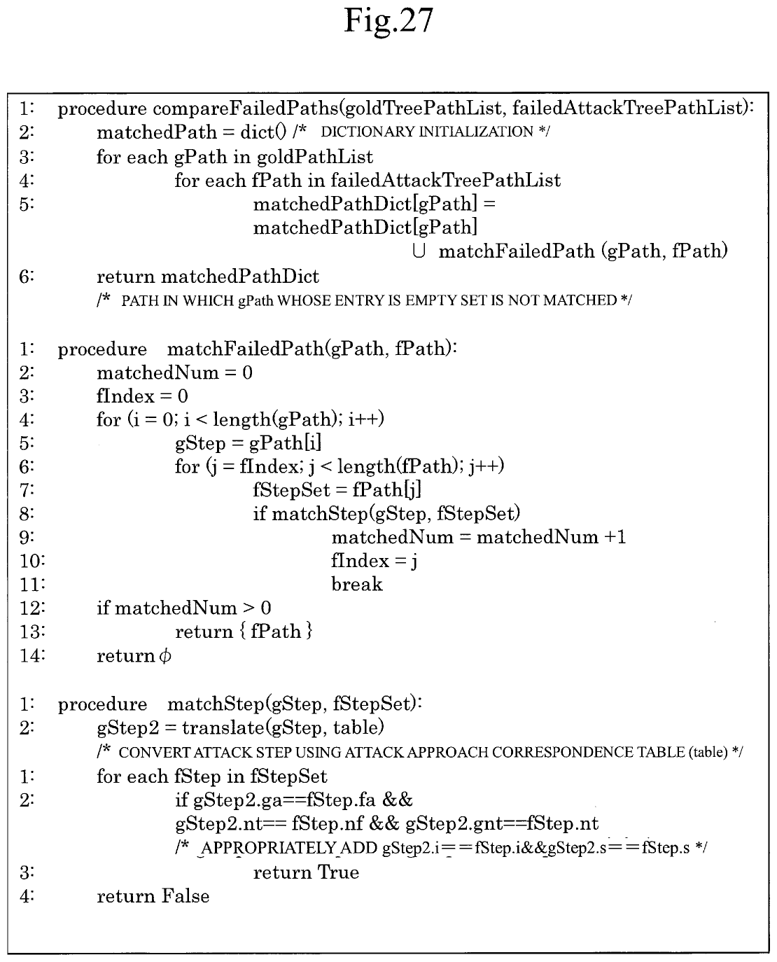

FIG. 27 illustrates a pseudo code (compareFailedPaths) that realizes the comparison operation of the path comparison unit 1032.

In step S2037, the path comparison unit 1032 generates an evaluation result by utilizing matchedAttackPathDict and matchedFailedAttackPathDict. The path comparison unit 1032 obtains two types of information from matchedAttackPathDict. A first piece of information is information about the attack path covering the gold tree in the evaluation tree. The information about this attack path is information of a set (COVERED_ATTACK_PATH_SET) of the attack path (aPath) of the evaluation tree defined in each entry (gPath) that is not an empty set (φ) in matchedAttackPathDict. This set is defined as a set of pairs ((gPath, aPath)) of the attack path of the gold tree and the attack path of the corresponding evaluation tree. When a plurality of attack paths of the evaluation tree correspond to one attack path of the gold tree, a plurality of pairs of the evaluation trees are included in a set ({(gPath1,aPath1),(gPath1,aPath2),(gPath1,aPath3)}).

A second piece of information is information about an attack path that is not covered by the evaluation tree. The information about this attack path is information of a set (UNCOVERED_PATH_SET) of each entry (gPath) which is an empty set (φ) in matchedAttackPathDict. There is a possibility that the inference rule and the prerequisite knowledge required for the attack tree automatic generation may include an attack path which is not needed to be covered. However, there is also a possibility that the inference rule and the prerequisite knowledge do not include a path which should be covered due to a setting-mistake in the inference rule or the prerequisite knowledge.

One type of information can be obtained from matchedFailedAttackPathDict. The information that can be obtained from matchedFailedAttackPathDict is information of the attack path in the failure tree, that covers the gold tree halfway. The information of this attack path is information of a set (COVERED_FAILED_PATH_SET) of the attack path (fPath) of the failure tree defined in each entry (gPath) which is not an empty set (φ) in matchedFailedAttackPathDic. This set is defined as a set of pairs ((gPath,fPath)) of the attack path of the gold tree and the attack path of the corresponding failure tree. When a plurality of attack paths of the failure tree correspond to one attack path of the gold tree, a plurality of pairs of the failure tree are included in a set ({(gPath1,fPath1), (gPath1,fPath2), (gPath1,fPath3)}).

Here, if the gPath included in UNCOVERED PATH SET is included in COVERED_FAIRD_PATH_SET, the gPath serves as a basis (condition for derivation failure) for a failure of a last intrusion procedure (condition) in a corresponding fPath. This set of pairs of gPath and fPath is referred to as

### NORMAL_UNCOVERED_PATH_SET.

If the gPath included in UNCOVERED_PATH_SET is not included in COVERED_FAILED_PATH_SET, it is expected that there is some problem in the prerequisite knowledge or the inference rule given to an inference engine. This set of gPath is referred to as ABNORMAL_UNCOVERED_PATH_SET.

Finally, in step S2038, the path comparison unit 1032 outputs an evaluation result to the display 907.

Specifically, the path comparison unit 1032 displays

### NORMAL_UNCOVERED_PATH_SET and

ABNORAML_UNCOVERED_PATH_SET as the evaluation result. For NORMAL_UNCOVERED_PATH_SET, if there exists a basis for a failure, the path comparison unit 1032 also displays the basis for the failure. For ABNORAML_UNCOVERED_PATH_SET, the path comparison unit 1032 can indicate to the user that the corresponding path may be left out from the evaluation tree due to a defect in the system knowledge 104, the attack knowledge 105, or the like.

### Description of Effect of Embodiment

According to the present embodiment, when a path that is not covered by the evaluation tree is extracted, it is possible to notify a user of a reason why the path is not covered by the evaluation tree. That is, as to a path included in PATH_PAIR_SET2, it is possible to notify the user that there is no defect in the system knowledge 104, the attack knowledge 105, or the like, and that the path is properly excluded from the evaluation tree. On the other hand, when there is UNCOVERED_PATH_SET, it is possible to notify the user that the corresponding path may be left out from the evaluation tree due to a defect in the system knowledge 104, the attack knowledge 105, or the like.

### Others

In the first embodiment, the evaluation tree generation unit 101 generates the evaluation tree. Instead of this, an apparatus outside the coverage evaluation device 100 may generate the evaluation tree according to the same method as the evaluation tree generation unit 101. In this case, the coverage evaluation device 100 is provided with a configuration (an evaluation tree acquisition unit) for acquiring an evaluation tree which is generated outside. The evaluation tree acquisition unit corresponds to the first attack tree acquisition unit.

Further, in the second embodiment, the failure tree generation unit 1033 generates the failure tree. Instead of this, an apparatus outside the coverage evaluation device 100 may generate the failure tree according to the same method as the failure tree generation unit 1033. In this case, the coverage evaluation device 100 is provided with a configuration (a failure tree acquisition unit) for acquiring a failure tree which is generated outside.

Although the embodiments of the present invention have been described above, these two embodiments may be combined and implemented.

Alternatively, one of these two embodiments may be partially implemented.

Alternatively, these two embodiments may be partially combined and implemented.

The present invention is not limited to these embodiments, and various modifications can be made as needed.

### Description of Hardware Configuration

Finally, supplementary descriptions of the hardware configuration of the coverage evaluation device 100 will be given.

The processor 901 illustrated in FIG. 1 is an IC (Integrated Circuit) that performs processing.

The processor 901 is a CPU (Central Processing Unit), a DSP (Digital Signal Processor), or the like.

The main storage device 902 illustrated in FIG. 1 is a RAM (Random Access Memory).

The auxiliary storage device 903 illustrated in FIG. 1 is a ROM (Read Only Memory), a flash memory, an HDD (Hard Disk Drive), or the like.

The communication device 904 illustrated in FIG. 1 is an electronic circuit that executes data communication processing.

The communication device 904 is, for example, a communication chip or an

NIC (Network Interface Card).

An OS is also stored in the auxiliary storage device 903.

Then, at least a part of the OS is loaded into the main storage device 902 and executed by the processor 901.

The processor 901 executes a program that realizes the functions of the evaluation tree generation unit 101, the gold tree generation unit 102, and the tree comparison unit 103 while executing at least the part of the OS.

When the processor 901 executes the OS, a task management, a memory management, a file management, communication control, and the like are performed.

Further, at least one of the information, data, a signal value, and a variable value indicating the processing result of the evaluation tree generation unit 101, the gold tree generation unit 102, and the tree comparison unit 103 is stored in at least one of the main storage device 902, the auxiliary storage device 903, and registers and cache memory in the processor 901.

The program that realizes the functions of the evaluation tree generation unit 101, the gold tree generation unit 102, and the tree comparison unit 103 may be stored in a portable recording medium such as a magnetic disk, a flexible disk, an optical disk, a compact disk, a Blu-ray (registered trademark) disk, or a DVD.

Further, “unit” of the evaluation tree generation unit 101, the gold tree generation unit 102, and the tree comparison unit 103 may be read as “circuit” or “step” or “procedure” or “process”.

Further, the coverage evaluation device 100 may be realized by a processing circuit. The processing circuit is, for example, a logic IC (Integrated Circuit), a GA (Gate Array), an ASIC (Application Specific Integrated Circuit), or an FPGA (Field-Programmable Gate Array).

In this case, the evaluation tree generation unit 101, the gold tree generation unit 102, and the tree comparison unit 103 are each realized as a part of the processing circuit.

In the present specification, a superordinate concept of the processor and the processing circuit is referred to as “processing circuitry”.

That is, each of the processor and the processing circuit is a specific example of the “processing circuitry”.

### REFERENCE SIGNS LIST

100: coverage evaluation device, 101: evaluation tree generation unit, 102: gold tree generation unit, 103: tree comparison unit, 104: system knowledge, 105: attack knowledge, 106: initial-stage intrusion template, 107: intrusion procedure template, 108: intrusion procedure conversion table, 901: processor, 902: main storage device, 903: auxiliary storage device, 904: communication device, 905: keyboard, 906: mouse, 907: display, 1021: network coverage unit, 1022: template applying unit, 1031: path extraction unit, 1032: path comparison unit, 1033: failure tree generation unit.

1. An information processing device comprising:
processing circuitry
to acquire as a first attack tree, an attack tree about an information system, which is based on inference using predicate logic;
to generate as a second attack tree, an attack tree which covers an intrusion route to the information system and reflects an intrusion procedure for the information system, by using network configuration information indicating a network configuration of the information system and intrusion procedure information indicating an intrusion procedure assumed in intrusion into the information system; and
to compare the first attack tree with the second attack tree.

2. The information processing device according to claim 1,
wherein the processing circuitry
acquires as the first attack tree, an attack tree which includes a plurality of attack paths each of which includes a plurality of attack steps,
generates as the second attack tree, an attack tree which includes a plurality of attack paths each of which includes a plurality of attack steps, and
when a plurality of attack steps included in a specific attack path included in the second attack tree are not included in the first attack tree in a same order as the second attack tree, outputs the specific attack path.

3. The information processing device according to claim 1,
wherein the processing circuitry
acquires as a failure tree, an attack tree which includes elements for which inference is failed in the inference using the predicate logic about the information system, and
compares the second attack tree with the first attack tree and the failure tree.

4. The information processing device according to claim 3,
wherein the processing circuitry
acquires as the first attack tree, an attack tree which includes a plurality of attack paths each of which includes a plurality of attack steps,
generates as the second attack tree, an attack tree which includes a plurality of attack paths each of which includes a plurality of attack steps,
acquires as the failure tree, an attack tree which includes a plurality of attack paths each of which includes a plurality of attack steps, and
when a plurality of attack steps included in a specific attack path included in the second attack tree are not included in either of the first attack tree and the failure tree in a same order as the second attack tree, outputs the specific attack path.

5. The information processing device according to claim 4,
wherein the processing circuitry outputs a message notifying that a premise of the inference using the predicate logic is assumed to have a defect.

6. The information processing device according to claim 3,
wherein when a plurality of attack steps included in a specific attack path included in the second attack tree are not included in the first attack tree in a same order as the second attack tree but are included in the failure tree, the processing circuitry outputs the specific attack path.

7. The information processing device according to claim 6,
wherein the processing circuitry outputs a message notifying that a premise of the inference using the predicate logic is assumed to have no defect.

8. An information processing method comprising:
acquiring as a first attack tree, an attack tree about an information system, which is based on inference using predicate logic;
generating as a second attack tree, an attack tree which covers an intrusion route to the information system and reflects an intrusion procedure for the information system, by using network configuration information indicating a network configuration of the information system and intrusion procedure information indicating an intrusion procedure assumed in intrusion into the information system; and
comparing the first attack tree with the second attack tree.

9. A non-transitory computer readable medium storing an information processing program which causes a computer to execute:
a first attack tree acquisition process of acquiring as a first attack tree, an attack tree about an information system, which is based on inference using predicate logic;
a second attack tree generation process of generating as a second attack tree, an attack tree which covers an intrusion route to the information system and reflects an intrusion procedure for the information system, by using network configuration information indicating a network configuration of the information system and intrusion procedure information indicating an intrusion procedure assumed in intrusion into the information system; and
a tree comparison process of comparing the first attack tree with the second attack tree.
